(19) United States
(12) Patent Application Publication
(10) Pub. No.: US 2021/0194933 A1
(43) Pub. Date: Jun. 24, 2021

(54) NEGOTIATION OF SECURITY FEATURES

(71) Applicant: Telefonaktiebolaget LM Ericsson (publ), Stockholm (SE)

(72) Inventor: Noamen BEN HENDA, VÄLLINGBY (SE)

(21) Appl. No.: 17/268,665

(22) PCT Filed: Aug. 20, 2018
(86) PCT No.: PCT/EP2018/072424

§ 371 Date: Feb. 16, 2021

(51) Int. Cl. H04L 29/06; H04W 12/106

(52) U.S. Cl. CPC H04L 63/205; H04W 12/106

(57) ABSTRACT

Embodiments presented herein relates to a method for negotiation of security features in a wireless communication system. The method is performed in a core network (CN) node 3 and comprises receiving a first message from a wireless terminal (WT), the first message including an indication that the WT 1 supports a new security feature, sending a second message to the WT, the second message including an indication of security features determined to be supported in the CN in response to the received first message, and receiving a third message from the WT, the third message including an indication of security features determined to be supported in the WT based on the sent CN determined security features. A method, CN nodes, WTs, computer programs, and a computer program product for negotiation of security features in a wireless communication system is also presented.

### TECHNICAL FIELD

The invention relates to methods, core network nodes, wireless terminals, computer programs and a computer program product for negotiation of security features in a wireless communication system.

### BACKGROUND

The architecture for the 4^{th} Generation Mobile Communication System, a.k.a. Long Term Evolution (LTE), is described in the 3^{rd} generation partnership project (3GPP) technical specification (TS) 23.401. FIG. 2 shows, the non-roaming reference architecture of evolved packet system (EPS) illustrated in figure 4.2.1-1 therein.

The security architecture for LTE is described in 3GPP TS 33.401. One of the most important goals of the security work in 3GPP is to protect the communication over the air interface LTE-Uu between the User Equipment (UE) and the Evolved Terrestrial Radio Access Network (E-UTRAN) which is the Access Network (AN). Therefore, LTE was designed so that all signalling could be integrity and confidentiality protected, while user data only confidentiality protected. In order to describe the security mechanisms, it is important to give insights on the different communicating channels between the UE and the network.

There are two levels of communications between the UE and the network. The first one is between the UE and the Mobility Management Entity (MME) in the Core Network (CN). This is only used for signalling and is over the Non-Access Stratum (NAS) protocol. The second level is between the UE and the evolved NodeB (eNB) in the E-UTRAN. This is used for both signalling and user data transport. The signalling is over the Radio Resource Control (RRC) protocol. RRC is transported over another protocol called Packet Data Convergence Protocol (PDCP). Meanwhile the user data is directly transported over the PDCP protocol.

In order to activate the security protection at the PDCP and NAS level, key establishment and selection of security algorithms need to take place. Key establishment is realized by the authentication procedure Authentication and Key Agreement (AKA) which results in a shared key called K_{ASME} between the UE and the MME in the serving network. This key is then used as the root key for the derivation of all subsequent keys such as for the NAS protocol protection and further keys for AS security. The selection of the algorithms is realized via Security Mode Command (SMC) procedures. There are separate procedures for NAS and AS, namely, one NAS SMC procedure and one AS SMC procedure.

As described in 3GPP TS 33.401, the NAS SMC procedure is a round trip of NAS messages used to agree on the security algorithms to be used and also to activate the integrity and confidentiality protection for the NAS protocol. The AS SMC achieves the same goal but for the RRC protocol and the User Plane (UP).

A discussion on the lack of UP integrity protection has recently been initiated. It has been suggested that new security features introduced in 5G could be also introduced in EPS, such as the permanent subscription identifier privacy and the temporary subscription identifier refreshment.

### SUMMARY

An object presented herein is how to enable negotiation of new features in wireless communication systems supported by a wireless terminal and a core network without breaking backward compatibility.

According to a first aspect there is presented a method for negotiation of security features in a wireless communication system. The method is performed in a core network (CN) node and comprises receiving a first message from a wireless terminal (WT), the first message including an indication that the WT supports a new security feature, sending a second message to the WT, the second message including an indication of security features determined to be supported in the CN in response to the received first message, and receiving a third message from the WT, the third message including an indication of security features determined to be supported in the WT based on the sent CN determined security features.

By the presented method, a backward compatible, secure and future-proof mechanism for the negotiation and activation of new security features in evolved packet system (EPS) is achieved, by piggybacking indications on the network supported features and the WT selected features in the Non-Access Stratum Security Mode Command (NAS SMC) procedure.

The method may further comprise determining that the received new security feature is supported by the CN, and activation of the WT determined security features, including the new security feature, in the CN in response to the received third message, wherein the second message may comprise a parameter indicating that the new security feature is support by the CN.

The second message may comprise a flag indicating support of the new security feature.

The first message may be an initial attach message, the second message may be a NAS security mode command message, and the third message may be a NAS security mode complete message.

The indication in the first message may be signalled by a spare bit in a security capability information element (IE).

According to a second aspect, there is presented a method for negotiation of security features in a wireless communication system. The method is performed in a WT and comprises sending a first message to a CN node, the first message including an indication that the WT supports a new security feature, receiving a second message from the CN node, the second message including an indication of security features determined to be supported in the CN in response to the sent first message, and sending a third message to the CN node, the third message including an indication of security features determined to be supported in the WT based on the CN determined security features.

The received second message may comprise a parameter indication that the new security feature is supported by the CN, the method further comprising determining that the received new security feature is supported by the WT, and activation of the WT determined security features, including the new security feature, subsequent sending the third message.

The second message may comprise a flag indicating support of the new security feature.

The first message may be an initial attach message, the second message may be a NAS security mode command message, and the third message may be a NAS security mode complete message.

The indication in the first message may be signalled by a spare bit in a security capability IE.

According to a third aspect, there is presented a CN node for negotiation of security features in a wireless communication system. The CN node comprises a processing circuitry and a computer program product storing instructions that, when executed by the processing circuitry, causes the CN node to receive a first message from a WT, the first message including an indication that the WT supports a new security feature, to send a second message to the WT, the second message including an indication of security features determined to be supported in the CN in response to the received first message, and to receive a third message from the WT, the third message including an indication of security features determined to be supported in the WT based on the sent CN determined security features.

According to a fourth aspect, there is presented a WT for negotiation of security features in a wireless communication system. The WT comprises a processing circuitry and a computer program product storing instructions that, when executed by the processing circuitry, causes the WT to send a first message to a CN node, the first message including an indication that the WT supports a new security feature, to receive a second message from the CN node, the second message including an indication of security features determined to be supported in the CN in response to the sent first message, and to send a third message to the CN node, the third message including an indication of security features determined to be supported in the WT based on the CN determined security features.

According to a fifth aspect, there is presented a CN node for negotiation of security features in a wireless communication system. The CN node comprises a communication manager for receiving a first message from a WT, the first message including an indication that the WT supports a new security feature, for sending a second message to the WT, the second message including an indication of security features determined to be supported in the CN in response to the received first message, and for receiving a third message from the WT, the third message including an indication of security features determined to be supported in the WT based on the sent CN determined security features.

According to a sixth aspect, there is presented a WT for negotiation of security features in a wireless communication system. The WT comprises a communication manager for sending a first message to a CN node, the first message including an indication that the WT supports a new security feature, receiving a second message from the CN node, the second message including an indication of security features determined to be supported in the CN in response to the sent first message, and for sending a third message to the CN node, the third message including an indication of security features determined to be supported in the WT based on the CN determined security features.

According to a seventh aspect, there is presented a computer program for negotiation of security features in a wireless communication system. The computer program comprises computer program code which, when run in a CN node, causes the CN node to receive a first message from a WT, the first message including an indication that the WT supports a new security feature, to send a second message to the WT, the second message including an indication of security features determined to be supported in the CN in response to the received first message, and to receive a third message from the WT, the third message including an indication of security features determined to be supported in the WT based on the sent CN determined security features.

According to an eighth aspect, there is presented a computer program for negotiation of security features in a wireless communication system. The computer program comprises computer program code which, when run in a WT, causes the WT to send a first message to a CN node, the first message including an indication that the WT supports a new security feature, to receive a second message from the CN node, the second message including an indication of security features determined to be supported in the CN in response to the sent first message, and to send a third message to the CN node, the third message including an indication of security features determined to be supported in the WT based on the CN determined security features.

A computer program product comprising a computer program and a computer readable storage means on which the computer program is stored is also presented.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment wherein embodiments presented herein can be applied;

FIG. 2 illustrates the non-roaming architecture for 3GPP access;

FIG. 3 is a schematic diagram illustrating signalling for embodiments presented herein;

FIGS. 4-5 are flow charts illustrating methods for embodiments presented herein;

FIGS. 6-7 are schematic diagrams illustrating some components of devices presented herein;

FIGS. 8-9 are schematic diagrams illustrating functional module of devices presented herein.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

New security features may in the future be introduced to evolved packet system (EPS) in order to enhance the level of security, to bring it up to the same level as in 5th Generation Mobile Communication System (5G).

There are three main issues for the introduction of any new security feature in EPS. First, since 4G is widely deployed, backward compatibility issues arise. How would the network, if upgraded with such a new security feature, cope with different types, upgraded and legacy, of user equipments (UEs). Every UE won't be upgraded simultaneously and some might even never be upgraded to support such a new security feature. The deployment of such features will undergo a potentially long transition phase (in years) during which upgraded and legacy, both networks and UEs, coexist and interact with each other. If this new security feature is standardized to be optional, some networks might choose to never deploy it. Therefore, a solution is needed to enable a network and a UE to negotiate and agree on the support and use of this new security feature.

The second issue is related to the activation of the security feature. This activation must be secured so that it is not vulnerable to bidding down attacks. One example of how this may be realized is for the selection of the Non-Access Stratum (NAS) security algorithms in the NAS Security Mode Command (SMC) procedure in EPS. The NAS SMC sent from the Mobility Management Entity (MME) to the UE containing the selected NAS algorithms and the replayed UE security capability is integrity protected by the selected NAS integrity algorithm.

The last issue is related to future proofness. More precisely, a solution for the negotiation and activation of new security feature should also cope with the potential introduction of multiple independent features. Here independent means that the network should be able to deploy and use any of the features independently.

Embodiments presented herein have the following advantages:
Negotiation of new features supported by the UE and the network is enabled without breaking backward compatibility
Security against bidding down attacks is provided by piggybacking the exchange of indication in the NAS SMC procedure
Support for the introduction of multiple independent features is provided
Not requiring introduction of new signaling messages, and being light weight

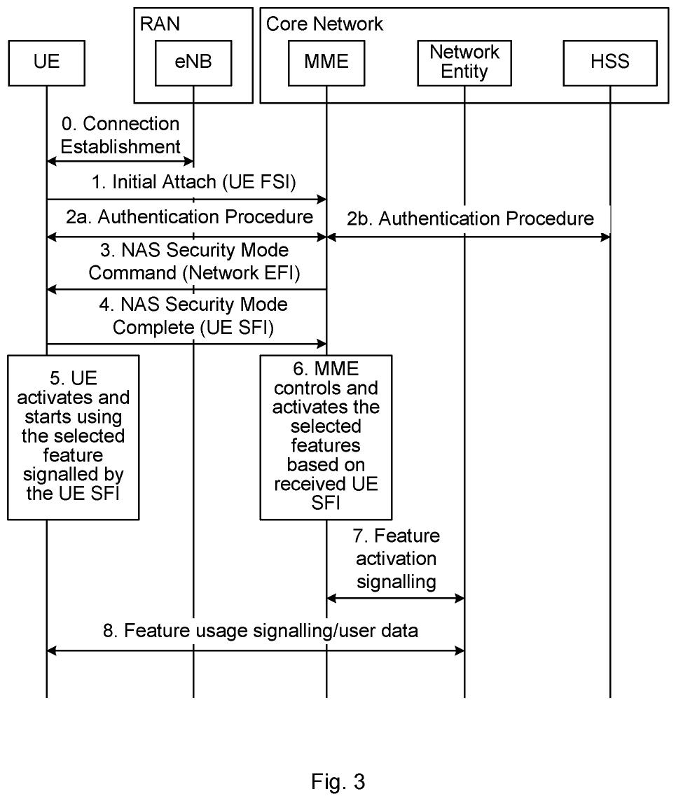

FIG. 3 highlights the steps related to a presented embodiment. The detailed description of the steps is given below.

Connection establishment is, in a step 0, performed between the UE and the radio access network (RAN) node (eNB).

The UE thereafter, in step 1, sends an initial attach message to the MME, optionally including a new parameter, here called UE Feature Support Indication (FSI), in order to inform the network that the UE supports a new security feature.

The MME, in response to the received initial attach, triggers the authentication procedure (AKA) in order to establish the anchor security key K_{ASME} between the UE and the MME. The AKA procedure includes signaling between the MME and the UE, and between the MME and a home subscriber server (HSS), illustrated with steps 2a and 2b, respectively. More details on the AKA procedure can be found in TS 33.401.

The MME then starts the NAS SMC procedure by sending, in step 3, a NAS SMC message to the UE, the message including e.g. the key set identifier (eKSI), the selected NAS security algorithms and the replayed UE security capabilities. In addition, if the MME has received the UE FSI and the networks supports the new security features then the MME includes a new parameter, here called network Enabled Features Indication (EFI), indicating to the UE which new security features are enabled.

The UE, in step 4, replies with the NAS Security Mode Complete message. Further details on the NAS SMC procedure can be found in TS 33.401. In addition, if the UE has received the network EFI parameter, then the UE includes an indication, here called UE Selected Feature Indication (SFI), to signal to the network which features among the ones enabled as indicated in the received EFI are selected and thus to be activated.

Based on the received EFI and sent SFI, the UE, in step 5, activates and starts using the selected security features.

Based on the received SFI, the MME, in step 6, may control that the selected features indicated by the UE SFI are among the ones signaled as enabled in the network EFI sent earlier (in step 3) and activates the selected features. The steps 5 and 6 are performed independent of each other and may be performed in either order, or in parallel.

The MME may, in step 7, optionally trigger additional signaling to activate the selected features should the feature require involving other network entities.

The UE and network, in step 8, start exchanging possibly signaling and user data using the selected and activated new security features.

In order to guarantee backward compatibility, the UE FSI may be signaled using one of the spare bits for algorithm support in the UE security capabilities Information Element (IE). For example, EIA 7 may be a reasonable choice since it is very unlikely that 5 new integrity algorithms are introduced within the lifetime of LTE.

An upgraded UE will have this spare bit set in its UE security capabilities. Consequently, the UE FSI is realized by the transmission of UE security capabilities that are included by default in the Initial Attach request message (step 1). An MME that is not supporting any new feature does not act on any of the spare bits whenever they are set and simply replays the UE security capabilities in the integrity protected NAS SM Command message (step 3) as expected. An upgraded MME acts on the spare bit that is set and sends back the network EFI parameter, here in a new IE. One advantage of this embodiment is that this additional UE FSI indication would benefit from the bidding down protection provided to the UE security capabilities. The biding down protection is realized by replaying back the UE security capabilities, received in the initial attach message (step 1), in the integrity protected NAS SMC message (step 3).

Using the algorithm spare bit in this way is however for a different purpose than that it was initially intended to. Another alternative is to use a separate new IE to signal the UE FSI parameter. Then the UE would first try to send the UE FSI as depicted in step 1. For a legacy MME, the attach procedure would fail, and the reject cause would for example indicate a missing or unsupported IE as described in TS 24.301. In such a case, the UE may reattempt the attach procedure, now without inclusion of this UE FSI IE.

This trial and error method may however add a delay to access service for upgraded UEs. This may be rectified if the network signals its support of the feature in the cell information by using a flag in one of the system information blocks (SIBs) or master information blocks (MIBs). An upgraded UE would then act on this indication which is acquired during the connection establishment (step 0). In a case the UE decides to use the new security feature, the UE includes the new IE carrying the UE FSI in the initial attach message (step 1). However, this embodiment has a minor impact on RAN since it requires the eNBs to broadcast such additional information.

In case multiple new security features are supported by the UE and the network, the UE may use one of the spare algorithm bits in the UE security capability IE to signal that it supports a new security feature indistinguishably of which one it is. This spare bit may be fixed and standardized for the sole purpose of signaling that the UE supports at least a new security feature.

On the network side, the EFI parameter may in response thereto include a sequence of bytes where each bit, whenever set, indicates that a particular security feature is enabled by the network. Each new security feature would then be associated with a bit in fixed and standardized positions in the sequence. The size of the parameter may be fixed to 1 or 2 bytes. 2 bytes mean that up 16 different security features can be signaled and negotiated by this embodiment. This is a reasonable limit since it is unlikely that so many new security features would be introduced during the lifetime of LTE. Another possibility is to not define any size limit on the EFI and require that the EFI IE transported in the NAS SM Command message (step 3) is of variable length.

The EFI parameter is not expected to be a constant, so that it is always set to indicate all the features that the network supports. The network may selectively indicate support for different features to different UEs, for example depending on subscription information. In this way, the network can control not only which features to enable with each UE, but also when. E.g. overload situations that could affect some of the supported features are contemplated. In such case, the network may not indicate that the feature is supported so that the UE does not select it.

The UE SFI parameters may be a sequence of bytes where each bit, whenever set, indicates that a particular feature has been selected by the UE and is to be activated. The same association between the bit position and the feature in the EFI parameter applies also to the SFI parameter. The UE calculates the SFI based on the received (step 3) EFI parameter. The UE may e.g. copy the EFI value and simply set the bits corresponding to unsupported features or features that the UE decides not to activate to 0 (change 1s to 0s). The UE has no interest in setting the bits associated with security features that are not indicated as enabled in the received EFI (change 0s to 1s). In such a case, the network may either reject the NAS SM Complete message (step 4) or simply ignore those bits.

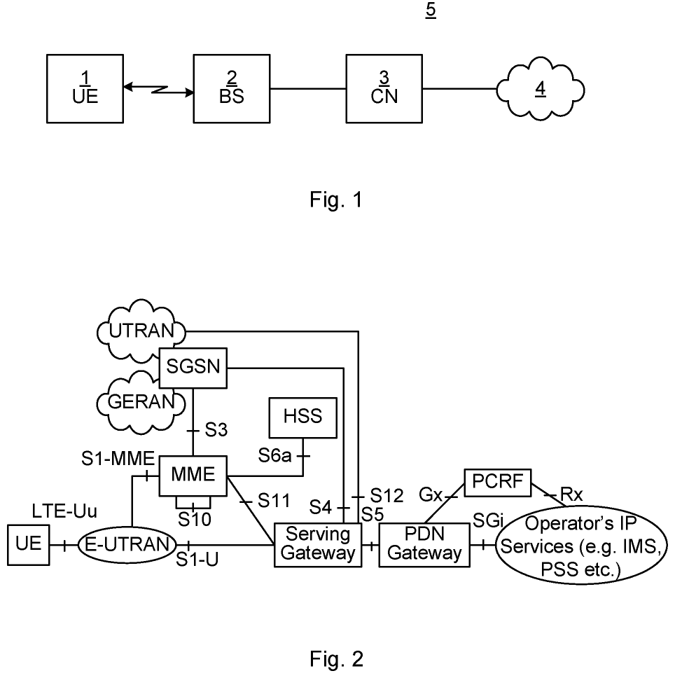

FIG. 1 is a schematic diagram illustrating an environment where embodiments presented herein can be applied. A UE 1 is in connectivity with a BS 2, in turn connected to a core network (CN) 3, all of a wireless communication system 5. The CN 3 may in turn be connected to Internet 4.

The UE 1 may e.g. be a user portable wireless device, mobile station, mobile phone, handset, wireless local loop phone, user equipment, smartphone, laptop computer, tablet computer, wireless modem, network equipped sensor, network equipped vehicle, wireless terminal (WT) and Internet-of-Things device. The BS 2 may e.g. be a radio access network node, radio base station, base transceiver station, backhaul network node, node B, evolved node B, g node B, access point, transmission and reception point.

It is to be noted that, while the embodiments presented herein are described as implemented using LTE (Long Term Evolution) any applicable communication standard may be used, such as any one or a combination of W-CDMA (Wideband Code Division Multiplex), LTE-SAE (Long Term Evolution—System Architecture Evolution), GSM (Global System for Mobile communication), EDGE (Enhanced Data Rates for GSM Evolution), GPRS (General Packet Radio Service), CDMA2000 (Code Division Multiple Access 2000), or any other current or future wireless network, such as LTE-Advanced or 5G NR (New Radio), as long as the principles described herein are applicable.

An embodiment of a method for negotiation of security features in a wireless communication system is presented with reference to FIG. 5. The method is performed in a CN node 3 and comprises receiving S300 a first message from a WT, the first message including an indication that the WT 1 supports a new security feature, sending S320 a second message to the WT, the second message including an indication of security features determined to be supported in the CN in response to the received first message, and receiving S330 a third message from the WT, the third message including an indication of security features determined to be supported in the WT based on the sent CN determined security features.

The method may further comprise determining S310 that the received new security feature is supported by the CN, and activation S340 of the WT determined security features, including the new security feature, in the CN in response to the received third message, wherein the second message comprises a parameter indicating that the new security feature is support by the CN.

The second message may comprise a flag indicating support of the new security feature.

The first message may be an initial attach message, the second message may be a NAS security mode command message, and the third message may be a NAS security mode complete message.

The indication in the first message may be signalled by a spare bit in a security capability IE.

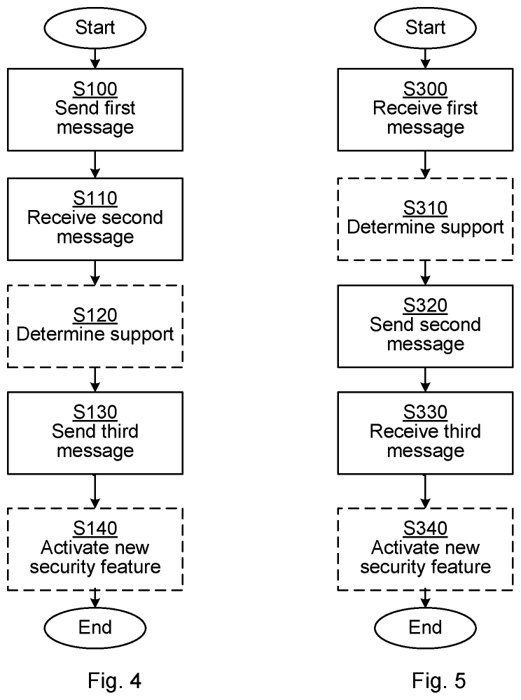

An embodiment of a method for negotiation of security features in a wireless communication system is presented with reference to FIG. 4. The method is performed in a WT 1 and comprises sending S100 a first message to a CN node 3, the first message including an indication that the WT supports a new security feature, receiving S110 a second message from the CN node, the second message including an indication of security features determined to be supported in the CN in response to the sent first message, and sending S130 a third message to the CN node, the third message including an indication of security features determined to be supported in the WT based on the CN determined security features.

The received second message may comprise a parameter indication that the new security feature is supported by the CN, the method may further comprise determining S120 that the received new security feature is supported by the WT, and activation S140 of the WT determined security features, including the new security feature, subsequent sending the third message.

The second message may comprise a flag indicating support of the new security feature.

The first message may be an initial attach message, the second message may be a NAS security mode command message, and the third message may be a NAS security mode complete message.

The indication in the first message may be signalled by a spare bit in a security capability IE.

An embodiment of a CN node for negotiation of security features in a wireless communication system is presented with reference to FIG. 7. The CN node 3 comprises a processing circuitry 30 and a computer program product 32, 33 storing instructions 34, 35 that, when executed by the processing circuitry, causes the CN node to receive a first message from a WT, the first message including an indication that the WT 1 supports a new security feature, to send a second message to the WT, the second message including an indication of security features determined to be supported in the CN in response to the received first message, and to receive a third message from the WT, the third message including an indication of security features determined to be supported in the WT based on the sent CN determined security features.

The CN node may further be caused to determine that the received new security feature is supported by the CN, and to activate the WT determined security features, including the new security feature, in the CN in response to the received third message, wherein the second message comprises a parameter indicating that the new security feature is support by the CN.

FIG. 7 is a schematic diagram showing some components of the CN node 3. The processing circuitry 30 may be provided using any combination of one or more of a suitable central processing unit, CPU, multiprocessing circuitry, microcontroller, digital signal processing circuitry, DSP, application specific integrated circuit etc., capable of executing software instructions of a computer program 34 stored in a memory. The memory can thus be considered to be or form part of the computer program product 32. The processing circuitry 30 may be configured to execute methods described herein with reference to FIG. 5.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 33 in the form of a data memory may also be provided, e.g. for reading and/or storing data during execution of software instructions in the processing circuitry 30. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 35, to improve functionality for the CN node 3.

The CN node 3 may further comprise an input/output (I/O) interface 31 including e.g. a user interface. The CN node 3 may further comprise a receiver configured to receive signalling from other nodes, and a transmitter configured to transmit signalling to other nodes (not illustrated). Other components of the CN node 3 are omitted in order not to obscure the concepts presented herein.

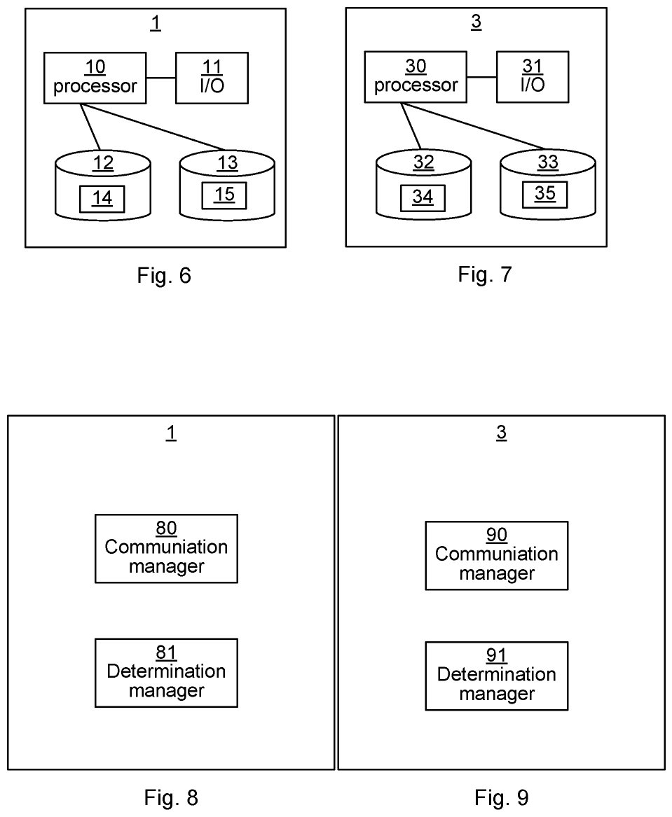

An embodiment of a WT for negotiation of security features in a wireless communication system is presented with reference to FIG. 6. The WT 1 comprises a processing circuitry 10 and a computer program product 12, 13 storing instructions 14, 15 that, when executed by the processing circuitry, causes the WT to send a first message to a CN node 3, the first message including an indication that the WT supports a new security feature, to receive a second message from the CN node, the second message including an indication of security features determined to be supported in the CN in response to the sent first message, and to send a third message to the CN node, the third message including an indication of security features determined to be supported in the WT based on the CN determined security features.

The received second message may comprise a parameter indication that the new security feature is supported by the CN, the WT then further caused to determine that the received new security feature is supported by the WT, and to activate the WT determined security features, including the new security feature, subsequent sending the third message.

FIG. 6 is a schematic diagram showing some components of the WT 1. The processing circuitry 10 may be provided using any combination of one or more of a suitable central processing unit, CPU, multiprocessing circuitry, microcontroller, digital signal processing circuitry, DSP, application specific integrated circuit etc., capable of executing software instructions of a computer program 14 stored in a memory. The memory can thus be considered to be or form part of the computer program product 12. The processing circuitry 10 may be configured to execute methods described herein with reference to FIG. 4.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processing circuitry 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the WT 1.

The WT 1 may further comprise an input/output (I/O) interface ii including e.g. a user interface. The WT 1 may further comprise a receiver configured to receive signalling from other nodes, and a transmitter configured to transmit signalling to other nodes (not illustrated). Other components of the WT 1 are omitted in order not to obscure the concepts presented herein.

An embodiment of a CN node for negotiation of security features in a wireless communication system is presented with reference to FIG. 9. The CN node 3 comprises a communication manager 90 for receiving a first message from a WT, the first message including an indication that the WT 1 supports a new security feature, for sending a second message to the WT, the second message including an indication of security features determined to be supported in the CN in response to the received first message, and for receiving a third message from the WT, the third message including an indication of security features determined to be supported in the WT based on the sent CN determined security features.

FIG. 9 is a schematic diagram showing functional blocks of the CN node 3. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the method illustrated in FIG. 5, comprising a communication manager unit 90 and a determination manger unit 91. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manager 90 is for negotiation of security features in a wireless communication system. This module corresponds to the steps S3oo, S320 and S330 of FIG. 5. This module can e.g. be implemented by the processing circuitry 30 of FIG. 7, when running the computer program.

The determination manger 91 is for negotiation of security features in a wireless communication system. This module corresponds to the steps S310, and S340 of FIG. 5. This module can e.g. be implemented by the processing circuitry 30 of FIG. 7, when running the computer program.

An embodiment of a WT for negotiation of security features in a wireless communication system is presented with reference to FIG. 8. The WT 1 comprises a communication manager 80 for sending a first message to a CN node 3, the first message including an indication that the WT supports a new security feature, receiving a second message from the CN node, the second message including an indication of security features determined to be supported in the CN in response to the sent first message, and for sending a third message to the CN node, the third message including an indication of security features determined to be supported in the WT based on the CN determined security features.

FIG. 8 is a schematic diagram showing functional blocks of the WT 1. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the method illustrated in FIG. 4, comprising a communication manager unit 80 and a determination manger unit 81. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manager 80 is for negotiation of security features in a wireless communication system. This module corresponds to the steps S100, S110 and S130 of FIG. 4. This module can e.g. be implemented by the processing circuitry 10 of FIG. 6, when running the computer program.

The determination manger 81 is for negotiation of security features in a wireless communication system. This module corresponds to the steps S120, and S140 of FIG. 4. This module can e.g. be implemented by the processing circuitry 10 of FIG. 6, when running the computer program.

An embodiment of a computer program 32, 33 for negotiation of security features in a wireless communication system is presented with reference to FIG. 7. The computer program comprises computer program code which, when run in a CN node, causes the CN node 3 to receive S3oo a first message from a WT, the first message including an indication that the WT 1 supports a new security feature, to send S320 a second message to the WT, the second message including an indication of security features determined to be supported in the CN in response to the received first message, and to receive S330 a third message from the WT, the third message including an indication of security features determined to be supported in the WT based on the sent CN determined security features.

An embodiment of a computer program 12, 13 for negotiation of security features in a wireless communication system is presented with reference to FIG. 6. The computer program comprises computer program code which, when run in a WT, causes the WT 1 to send S100 a first message to a CN node 3, the first message including an indication that the WT supports a new security feature, to receive S110 a second message from the CN node, the second message including an indication of security features determined to be supported in the CN in response to the sent first message, and to send S130 a third message to the CN node, the third message including an indication of security features determined to be supported in the WT based on the CN determined security features.

A computer program product 12, 13, 32, 33 comprising a computer program 14, 15, 34, 35 and a computer readable storage means on which the computer program 14, 15, 34, 35 is stored is also presented.

The invention has mainly been described above with reference to a few embodiments. However, as is readily appreciated by a person skilled in the art, other embodiments than the ones disclosed above are equally possible within the scope of the invention, as defined by the appended patent claims.

1. A method for negotiation of security features in a wireless communication system, the method being performed in a core network, CN, node and comprising:
receiving a first message from a wireless terminal, WT, the first message including an indication that the WT supports a new security feature;
sending a second message to the WT, the second message including an indication of security features determined to be supported in the CN in response to the received first message; and
receiving a third message from the WT, the third message including an indication of security features determined to be supported in the WT based on the sent CN determined security features.

2. The method according to claim 1, further comprising:
determining that the received new security feature is supported by the CN; and
activation of the WT determined security features, including the new security feature, in the CN in response to the received third message,
wherein the second message comprises a parameter indicating that the new security feature is support by the CN.

3. The method according to claim 1, wherein the second message comprises a flag indicating support of the new security feature.

4. The method according to claim 1, wherein the first message is an initial attach message, the second message is a non-access, NAS, security mode command message, and the third message is a NAS security mode complete message.

5. The method according to claim 1, wherein the indication in the first message is signalled by a spare bit in a security capability information element, IE.

6. A method for negotiation of security features in a wireless communication system, the method being performed in a wireless terminal, WT, and comprising:
sending a first message to a core network, CN, node, the first message including an indication that the WT supports a new security feature;
receiving a second message from the CN node, the second message including an indication of security features determined to be supported in the CN in response to the sent first message; and
sending a third message to the CN node, the third message including an indication of security features determined to be supported in the WT based on the CN determined security features.

7. The method according to claim 6, wherein the received second message comprises a parameter indication that the new security feature is supported by the CN, the method further comprising:
determining that the received new security feature is supported by the WT; and
activation of the WT determined security features, including the new security feature, subsequent sending the third message.

8. The method according to claim 6, wherein the second message comprises a flag indicating support of the new security feature.

9. The method according to claim 6, wherein the first message is an initial attach message, the second message is a non-access, NAS, security mode command message, and the third message is a NAS security mode complete message.

10. The method according to claim 6, wherein the indication in the first message is signalled by a spare bit in a security capability information element, IE.

11. A core network, CN, node for negotiation of security features in a wireless communication system, the CN node comprising:
a processing circuitry; and
a computer program product storing instructions that, when executed by the processing circuitry, causes the CN node to:
receive a first message from a wireless terminal, WT, the first message including an indication that the WT supports a new security feature;
send a second message to the WT, the second message including an indication of security features determined to be supported in the CN in response to the received first message; and
receive a third message from the WT, the third message including an indication of security features determined to be supported in the WT based on the sent CN determined security features.

12. The CN node according to claim 11, the CN node further caused to:
determine that the received new security feature is supported by the CN; and
activate the WT determined security features, including the new security feature, in the CN in response to the received third message,
wherein the second message comprises a parameter indicating that the new security feature is support by the CN.

13. The CN node according to claim 11, wherein the second message comprises a flag indicating support of the new security feature.

14. The CN node according to claim 11, wherein the first message is an initial attach message, the second message is a non-access, NAS, security mode command message, and the third message is a NAS security mode complete message.

15. The CN node according to claim 11, wherein the indication in the first message is signalled by a spare bit in a security capability information element, IE.

16. A wireless terminal, WT, for negotiation of security features in a wireless communication system, the WT comprising:
a processing circuitry; and
a computer program product storing instructions that, when executed by the processing circuitry, causes the WT to:
send a first message to a core network, CN, node, the first message including an indication that the WT supports a new security feature;
receive a second message from the CN node, the second message including an indication of security features determined to be supported in the CN in response to the sent first message; and
send a third message to the CN node, the third message including an indication of security features determined to be supported in the WT based on the CN determined security features.

17. The WT according to claim 16, wherein the received second message comprises a parameter indication that the new security feature is supported by the CN, the WT further caused to:
determine that the received new security feature is supported by the WT; and
activate the WT determined security features, including the new security feature, subsequent sending the third message.

18. The WT according to claim 16, wherein the second message comprises a flag indicating support of the new security feature.

19. The WT according to claim 16, wherein the first message is an initial attach message, the second message is a non-access, NAS, security mode command message, and the third message is a NAS security mode complete message.

20. The WT according to claim 16, wherein the indication in the first message is signalled by a spare bit in a security capability information element, IE.

21.-25. (canceled)
